(19) United States
(12) Patent Application Publication
(10) Pub. No.: US 2022/0405771 A1
(43) Pub. Date: Dec. 22, 2022

(54) CLOUD BASED PLATFORM FOR MANAGING LICENSES

(71) Applicant: Rebric, Inc. DBA Compliable, Denver, CO (US)

(72) Inventors: Chris Oltyan, Lakewood, CO (US); Ben Neil, Brighton, CO (US); Isabella Merjanian, Austin, TX (US); Timothy Sean McKnight, Littleton, CO (US)

(21) Appl. No.: 17/684,366

(22) Filed: Mar. 1, 2022

Related U.S. Application Data
(60) Provisional application No. 63/213,597, filed on Jun. 22, 2021.
(60) Provisional application No. 63/297,599, filed on Jan. 7, 2022.

(51) Int. Cl. G06Q 30/00; G06F 40/174

(52) U.S. Cl. CPC G06Q 30/018; G06F 40/174

(57) ABSTRACT

A compliance management system is provided which includes a personal information database, and a processor executing instructions that provide a number of functional modules. The modules include a dashboard module to receive personal information regarding a licensee, and to store in in the personal information database, and a document request module to retrieve a license form from a website or remote database. The modules also include a document preparation module to map each field within the license form to corresponding licensee information, and a document generation module to retrieve the information for each field and to place the corresponding retrieved information in the respective fields of the license form. The modules also include an overflow module to identify an overflowed field within the license form, and to generate an attachment for the license form including the information for that field.

### CROSS REFERENCE TO RELATED APPLICATIONS

This application claims the priority benefit under 35 U.S.C. § 119(e) of U.S. Provisional Patent Application No. 63/213,597 filed 22 Jun. 2021 and U.S. Provisional Patent Application No. 63/297599 filed 7 Jan. 2022, both of which are incorporated by reference in their entirety as though fully set forth herein.

### TECHNICAL FIELD

The subject matter described herein relates to methods, devices, and systems for collecting applicant data required for license applications and populating that data into license application forms. These methods, devices, and systems have particular but not exclusive utility for generating and maintaining license application forms for the gambling industry.

### BACKGROUND

The concept of filling out forms using stored data (e.g., autofill) is known, and may be used for example in web payments and other applications. However, such systems may expose user data in unencrypted forms, and may not be broadly applicable to multiple types of forms, or to the mass generation and submission of forms for multiple users.

Applying for gaming licenses can be a time-intensive and labor-intensive process, particularly when multiple individuals (e.g., multiple employees of a casino or online gaming site) need to apply simultaneously for gaming licenses in multiple states or jurisdictions. In such cases, similar but not identical data must be entered into multiple forms, for multiple users. Existing autofill solutions are not effective in such applications.

It should therefore be appreciated that such commonly used autofill solutions have numerous drawbacks, including low speed, poor usability, poor flexibility, poor data security, and otherwise. Accordingly, long-felt needs exist for systems that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a compliance management system which includes methods and/or devices for capturing data and translating that data to appropriate fields across a variety of different forms, for example to streamline the process of applying for regulatory or professional licenses. The system allows a user to fill in personal data on a single standardized form. The system collects and stores this data securely in an encrypted format, translates the collected data to the appropriate forms required to acquire the licenses, and constructs a packet of all required forms that will contain the latest information available, and then deletes unencrypted personal data from memory. The compliance management system disclosed herein has particular, but not exclusive, utility for creating and submitting gaming (e.g., gambling) licenses for multiple users.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a compliance management system that includes one or more processors; a personal information database; and a non-transitory computer-readable storage medium storing instructions, where the instructions, when executed by the one or more processors, cause the one or more processors to provide a plurality of functional modules. The functional modules include: a dashboard module configured to receive personal information related to a licensee, and to store the personal information in the personal information database; a document request module configured to automatically retrieve a license form from a website or remote database, where the license form includes a plurality of fields; a document preparation module configured to identify each field within the license form and map that field to corresponding information for the licensee within the personal information database; a document generation module configured to retrieve the corresponding information for each respective field within the license form for the licensee from the personal information database and to place the corresponding retrieved information in the respective fields of the license form to generate a completed form; and an overflow module configured to identify an overflowed field within the license form where a capacity of the overflowed field is insufficient to contain the retrieved information for that field, and to generate, based on a user input, an attachment for the license form including the retrieved information for that field. Other embodiments of this aspect include corresponding computer systems, apparatus, and computer programs recorded on one or more computer storage devices, each configured to perform the actions of the methods.

Implementations may include one or more of the following features. In some embodiments, the system further includes instructions to cause the one or more processors to provide a submit module configured to transmit the completed form and the attachment to a licensing authority. In some embodiments, the system further includes instructions to cause the one or more processors to provide a refresh module configured to, when personal information for the licensee stored in the personal information database is altered, repopulate the form using the document generation module and resubmit the form using the submit module. In some embodiments, the dashboard module is configured to receive the personal information related to the licensee through a single application form displayed on a display, where the personal information is entered with a keyboard and a pointing device. In some embodiments, the system further includes instructions to cause the one or more processors to provide: an encryption module configured to encrypt the personal information stored in the personal information database; and a decryption module configured to decrypt the personal information retrieved from the personal information database. In some embodiments, the personal information related to the licensee includes an image. In some embodiments, the personal information database is a nosql database. In some embodiments, the personal information database is cloud-based. In some embodiments, the document request module is configured to retrieve at least one license form of a plurality of different license forms. In some embodiments, the system further includes instructions to cause the one or more processors to provide a user interface within the dashboard module, the user interface including: an employee portal configured to accept first user inputs regarding a selected employee; and a compliance officer portal configured to accept second user inputs regarding at least one of a new employee, a plurality of new employees, an existing employee, an employee type, or a business contact. In some embodiments, the first user inputs include at least one of personal information, personal statements information, license information, license history information, employee tags, or notes. In some embodiments, the second user inputs include at least one of: a name of the employee type; a selection of forms associated with the employee type; employee information associated with an employee, the employee information including personal information, personal statements information, license information, license history information, employee tags, or notes; or business contact information associated with a business contact, the business contact information including name, contact information, business address, or mailing address. Implementations of the described techniques may include hardware, a method or process, or computer software on a computer-accessible medium.

One general aspect includes a method. The method includes receiving personal information related to a licensee, and storing the personal information in a personal information database; automatically retrieving a license form from a website or remote database, where the license form includes a plurality of fields; identifying each field within the license form and map that field to corresponding information for the licensee within the personal information database; and retrieving the corresponding information for each respective field within the license form for the licensee from the personal information database; and generating a completed form, including placing the corresponding retrieved information in the respective fields of the license form. Other embodiments of this aspect include corresponding computer systems, apparatus, and computer programs recorded on one or more computer storage devices, each configured to perform the actions of the methods.

Implementations may include one or more of the following features. In some embodiments, the method further includes: identifying an overflowed field within the license form where a capacity of the overflowed field is insufficient to contain the retrieved information for that field; and generating, based on a user input, an attachment for the license form including the retrieved information for that field. In some embodiments, the method further includes: transmitting the completed form and the attachment to a licensing authority. In some embodiments, the first user inputs include at least one of personal information, personal statements information, license information, license history information, employee tags, or notes; and accepting second user inputs regarding at least one of a new employee, a plurality of new employees, an existing employee, an employee type, or a business contact. In some embodiments, the second user inputs include at least one of: a name of the employee type; a selection of forms associated with the employee type; employee information associated with an employee, the employee information including personal information, personal statements information, license information, license history information, employee tags, or notes; or business contact information associated with a business contact, the business contact information including name, contact information, business address, or mailing address. Implementations of the described techniques may include hardware, a method or process, or computer software on a computer-accessible medium.

One general aspect includes a computer program product having a non-transitory computer readable medium tangibly recording computer program logic for managing license application compliance. The computer program product includes code to receive personal information related to a licensee, and to store the personal information in a personal information database; code to automatically retrieve a license form from a website or remote database, where the license form includes a plurality of fields; code to identify each field within the license form and map that field to corresponding information for the licensee within the personal information database; and code to retrieve the corresponding information for each respective field within the license form for the licensee from the personal information database and to place the corresponding retrieved information in the respective fields of the license form to generate a completed form. Other embodiments of this aspect include corresponding computer systems, apparatus, and computer programs recorded on one or more computer storage devices, each configured to perform the actions of the methods.

Implementations may include the computer program product further including: code to identify an overflowed field within the license form where a capacity of the overflowed field is insufficient to contain the retrieved information for that field, and to generate, based on a user input, an attachment for the license form including the retrieved information for that field. Implementations may also include code to transmit the completed form and the attachment to a licensing authority. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the compliance management system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is an exemplary representation, in flow diagram form, of at least a portion of an example compliance management system in accordance with at least one embodiment of the present disclosure.

FIG. 2 is an exemplary representation, in flow diagram form, of at least a portion of an example compliance management system in accordance with at least one embodiment of the present disclosure.

FIG. 3 is an exemplary representation, in block diagram form, of at least a portion of an example compliance management system in accordance with at least one embodiment of the present disclosure.

FIG. 4 is an exemplary representation, in block diagram form, of at least a portion of an example compliance management system in accordance with at least one embodiment of the present disclosure.

FIG. 5 is a schematic diagram of a processor circuit, according to embodiments of the present disclosure.

FIG. 6 shows an “Add Employees” screen of an example compliance management system, in accordance with at least one embodiment of the present disclosure.

FIG. 7 shows a “Manage Employees” screen of an example compliance management system, in accordance with at least one embodiment of the present disclosure.

FIG. 8 shows a “Manage Employees” screen of an example compliance management system, in accordance with at least one embodiment of the present disclosure.

FIG. 9 is an exemplary representation, in flow diagram form, of at least a portion of an example compliance management method in accordance with at least one embodiment of the present disclosure.

FIG. 10 is an exemplary representation, in flow diagram form, of at least a portion of an example compliance management method, in accordance with at least one embodiment of the present disclosure.

FIG. 11 shows a personal statement selector screen of an example compliance management system, in accordance with at least one embodiment of the present disclosure.

FIG. 12 is an exemplary representation, in flow diagram form, of at least a portion of an example compliance management method, in accordance with at least one embodiment of the present disclosure.

FIG. 13 is an employee profile screen of an example compliance management system, in accordance with at least one embodiment of the present disclosure.

FIG. 14 is an exemplary representation, in flow diagram form, of at least a portion of an example compliance management method, in accordance with at least one embodiment of the present disclosure.

FIG. 15 is a completed personal statement selector screen of an example compliance management system, in accordance with at least one embodiment of the present disclosure.

FIG. 16 is a side navigation and completion indicators screen of an example compliance management system, in accordance with at least one embodiment of the present disclosure.

### DETAILED DESCRIPTION

In accordance with at least one embodiment of the present disclosure, a compliance management system is provided which streamlines the process of applying for licenses (e.g., gaming licenses) by allowing a centralized server to send out requests to a variety of people, whether employees or external vendors, to fill in various personal data in a standardized form. The system collects and stores this data securely in an encrypted format, and tracks the status of the entire license application process. After all information is collected, there is a decryption and translation of the collected data to the appropriate forms (e.g., state or federal government forms, insurance forms, etc.) required to acquire licenses. This translation intelligently interprets and maps the personal data to the forms, e.g., by converting the word “Brown” describing hair color to an appropriate field or checkbox in a form as needed, since different jurisdictions, or different forms within the same jurisdiction, may require different locations or formats for the same information. Likewise, “Address” could be a single line in one form, and could be four or more separate lines in another (e.g., Address line 1, Address line 2, City, State, Zip, Country). After the system translates the data to the appropriate forms, the system can construct a packet of all required forms that will contain the latest information available, and then, after downloading, can delete that unencrypted data from the system, so that the system does not retain any instances of private information in an unencrypted state.

The present disclosure may aid substantially in populating and filing license applications for multiple applicants, or applicants in multiple jurisdictions, by improving both the security of personally identifying information (PII) and the efficiency with which licenses can be applied for. Implemented on one or more processors in communication with one or more databases, the compliance management system disclosed herein provides practical, secure translation of stored PII into field data for printable or transmissible license application forms. This streamlined and augmented process transforms a plurality of license applications into a single PII form for each user or applicant, without the normally routine need to copy and paste fields into multiple forms, to adapt information manually to different formats or different numbers and sizes of fields, or to store or handle PII in an insecure manner, as would occur in a manual or autofill process. This unconventional approach improves the functioning of computer systems used for compliance management, by centralizing and automating critical functions, while intelligently adapting stored data to fit a variety of different application forms in real time or near real time. With the system described herein, PII may be stored only in encrypted formats, and may be encrypted and decrypted on the fly, in real time or near real time, to prevent PII from being exposed except in the generated license application form itself.

The compliance management system improves the functioning of a computer system in several ways. First, it allows all the blank forms required for a given employee to be downloaded once, from multiple remote sources (e.g., the websites of government agencies or certifying authorities), into a single computer (e.g., local to a particular workplace) so that the blank forms are available when needed. This may for example reduce the need for multiple downloads of the same forms, thus reducing computing time and network usage. Second, for a given employee or other entity, the compliance management system allows a user to fill out all the required fields for all required forms by answering questions on a single, unified form, which may reduce the amount of time the local computer is tied up with form completions, thus freeing up the computer for other uses. Third, the compliance management system automates many processes as described below, thus reducing the time required to complete applications. Fourth, the compliance management system stores keys and personal data in an encrypted format, thus increasing the security of critical user data, while also decrypting specific data items in real time, as needed, to improve accessibility of the encrypted data. Still other advantages will be apparent in the descriptions provided below.

In some embodiments, the compliance management system may be implemented as a single-page application (SPA) or other application at least partially viewable on a display, and operated by a control process executing on a processor that accepts user inputs from a keyboard, mouse, or touchscreen interface, and that is in communication with one or more servers or databases, whether local, remote, cloud-based, or combinations thereof. In that regard, the control process performs certain specific operations in response to different inputs or selections made at different times. Other operations may be performed in parallel. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the compliance management system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Flow diagrams and block diagrams are provided herein for exemplary purposes; a person of ordinary skill in the art will recognize myriad variations that nonetheless fall within the scope of the present disclosure.

For example, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, or several million per second, in a single processor or across a plurality of processors. Such rapid execution may be necessary in order to execute the method in real time or near-real time as described herein. For example, during real-time operations the compliance management system performs encryption key authentication, encrypts/decrypts employee personal data, formats output documents, deletes information after a specified “time to live” has expired, executes appropriate data translations, applies translated data to corresponding form fields, and provides form download links or other actions to the use.

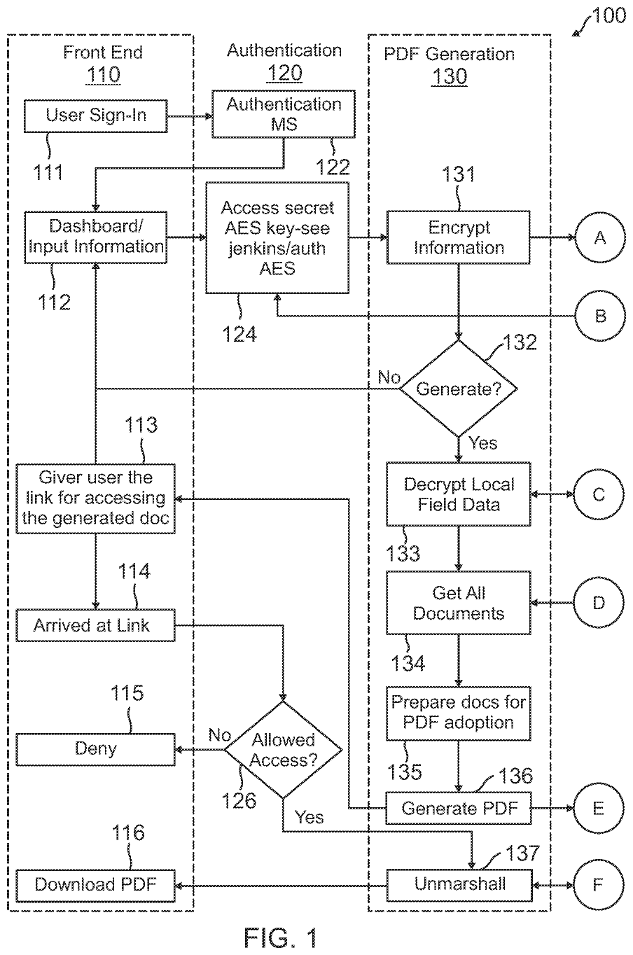

FIG. 1 is an exemplary representation, in flow diagram form, of at least a portion of an example compliance management system 100 in accordance with at least one embodiment of the present disclosure. The compliance management system 100 may for example include compileable or executable application code stored on a non-volatile computer-readable medium, to support web services and a single-page application (SPA) or other application involved in allowing a client to sign in and create a pdf document from a desired downloadable form such as a gaming license application form.

In the example shown in FIG. 1, the compliance management system 100 includes three layers: a front end layer, front end module, or dashboard module 110, an authentication layer or authentication nodule 120, and a portable document format (PDF) generation layer or module 130.

The front end layer, front end module, or dashboard module 110 includes a user sign-in step 111, which enables an authorized user to access the functionality of the compliance management system 100. Execution then proceeds to step 122. The front end layer 110 further includes an input step 112, wherein the user enters personal information through the dashboard module or other front-end module/device. Execution may then proceed to step 124. The front end layer 110 further includes an access step 113, wherein the PDF generation module 130 provides the user with a link for accessing a generated document such as a license application form. Depending on user inputs (e.g., through a graphical user interface as described below), the user may then return to step 112, or proceed to step 114. The front end layer 110 further includes an “arrived at link” step 114, from which execution then proceeds to step 126. The front end layer 110 further includes a “deny” step or endpoint 115, wherein the user is not allowed to access the link. The front end layer 110 further includes a “download PDF” step or endpoint 116, wherein the completed PDF application form and any associated documents are downloaded from the document microservice 204 for viewing, saving, emailing, uploading, printing, or other access by a user of the compliance management system 100. In some embodiments, this step may include or be at least partially implemented by a submit module configured to transmit the completed form and the attachment to a licensing authority (e.g., the authority from which the blank form was downloaded).

The authentication layer 120 includes an authentication service 122 to confirm that the signed-in user has presented valid credentials. Execution then proceeds to step 112. The authentication layer 124 further includes a secret key access step 124, wherein the authentication module 120 accesses an encryption key (e.g., an Advanced Encryption Standard or AES key), for example with a “jenkins/auth” plugin module or similar tool. In an example, when the “auth” service is deployed, a special key in the Jenkins web user interface is deployed alongside the containerized application as an environment variable. This key is used to encrypt/decrypt the employee token, which is used to encode/decode the employee's personal information. Execution then proceeds to step 131. The authentication layer 120 further includes a branch 126 to determine whether the user has been allowed access to a provided link to a PDF document. If yes, execution proceeds to step 137. If no (e.g., because it is the wrong user), execution proceeds to step 115.

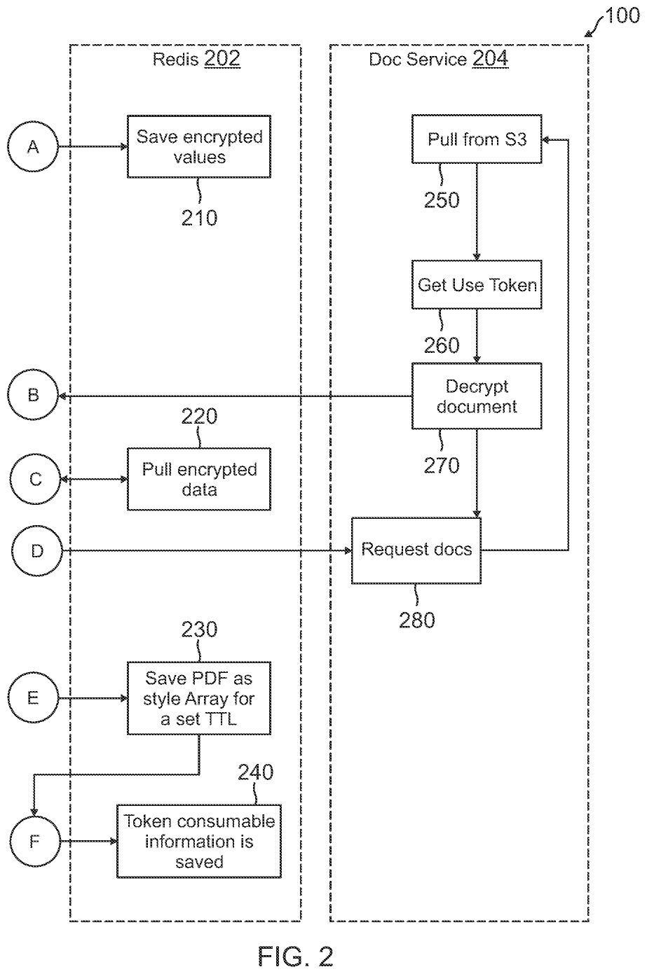

The PDF generation layer or PDF generation module 130 includes an encryption step 131, wherein the user's personal information is encrypted using the key (e.g., an AES key) obtained in step 124. Execution then proceeds to step 210 (see FIG. 2). In an example, all microservice communication is not done on a peer-to-peer basis between modules or layers, but through a network address translation system (NATS) message bus. In an example, user/employee information may be moved into database tables such as DynamoDB tables.

The PDF generation layer 130 also includes a branch 132 where it is determined (e.g., based on a user input, or the completeness of the personal information) whether or not to generate an application form from the personal information. If yes, execution proceeds to step 133. If no, execution proceeds to step 112. Step 133 calls step 220 (See FIG. 2) as a subroutine, and then decrypts the personal information necessary to populate a desired license application form. In step 134, the PDF generation module 130 downloads documents from a remote source (e.g., downloading license application documents from a website or server). Execution them proceeds to step 135. In step 135, the downloaded documents are prepared for PDF adoption, for example by populating the fields of each document with data from the personal information. This step may include or may be implemented by a document preparation module (e.g., configured to identify each field within the license form and map that field to corresponding information for the licensee within the personal information database). Execution then proceeds to step 136, wherein the completed PDF document is generated. This step may include or be implemented by a document generation module that is, for example, configured to retrieve (e.g., from memory in an unencrypted state or from encrypted storage, with a decryption step) the mapped information for each field within the license form for the selected licensee and to place the retrieved requested information in corresponding fields of the license form to generate a completed form. This step may also include or be partially implemented by an overflow module configured to identify fields within the selected license form that are too small to accommodate the corresponding personal information, and to generate (e.g., based on a user input) an attachment for the license form including the corresponding personal information. Execution then proceeds to step 230 (see FIG. 2). In step 137, the completed PDF form containing the personal information is unmarshaled (e.g., decoded from the marshaled state) such that it is available for download by the front end 110. Execution then proceeds to step 116 and/or step 240 (see FIG. 2).

Before continuing, it should be noted that the examples described above are provided for purposes of illustration, and are not intended to be limiting. Other devices and/or device configurations may be utilized to carry out the operations described herein.

FIG. 2 is an exemplary representation, in flow diagram form, of at least a portion of an example compliance management system 100 in accordance with at least one embodiment of the present disclosure. In the example shown in FIG. 2, the compliance management system 100 further includes two additional layers or modules: a remote dictionary server (redis) layer or module 202, and a document service layer or module 204.

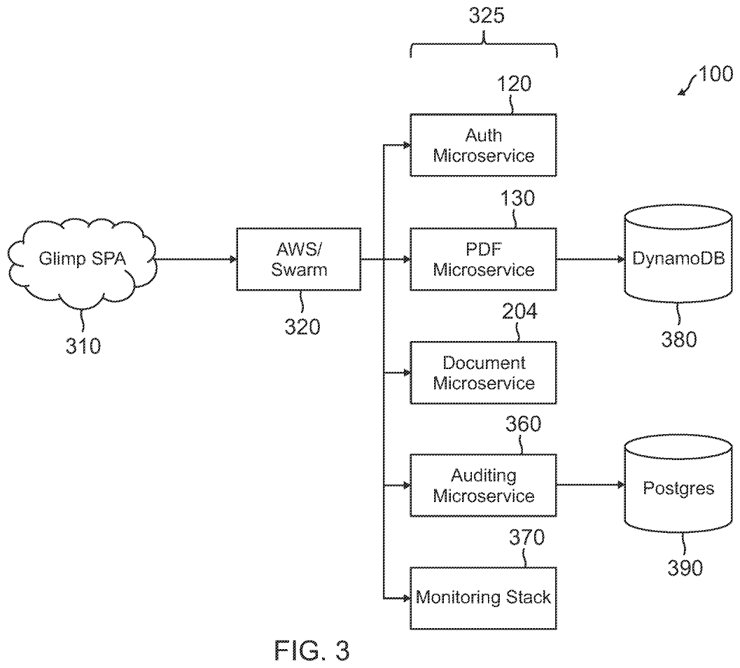

The redis layer 202 may for example include steps 210, 220, 230, and 240. The document service layer or module 204 may for example include steps 250, 260, 270, and 280. In step 210, encrypted values of the personal information are saved, for example in a database (e.g., a local database, server database, web database, or cloud database). In step 220, encrypted values of the personal information are retrieved from the database. In step 230, the PDF of the populated document (e.g., a filled-out license application form) is saved as a style array for a set “time to live” or TTL, a real-time value. Execution then proceeds to step 137 (see FIG. 1). When the TTL has expired, the style array is deleted from memory. In step 240, the consumable information regarding the AES token is saved to a user database (e.g., database 380 of FIG. 3).

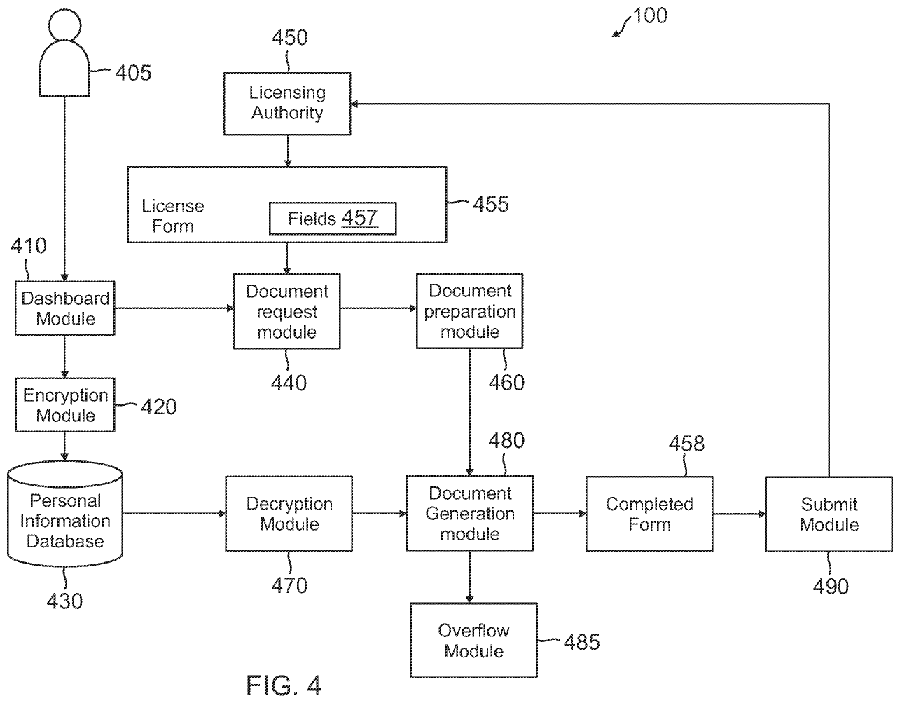

In the example shown in FIG. 2, the document service layer or document service module 204 includes a step 250, wherein encrypted personal information about the applicant (e.g., identification(s), personal documents, etc.) is pulled from a file store (e.g., from S3, a file store in Amazon Web Services). Execution then proceeds to step 260. In step 260, the document service module 204 gets a use token (e.g., a personal token used to decrypt the encrypted documents) from the file store. In step 270, the downloaded document(s) are decrypted, if necessary. Execution them proceeds to step 280 and/or step 124 (see FIG. 1). In step 280, documents (e.g., license application forms) are requested from a remote source (e.g., a website, server, cloud database, or other database). In some embodiments, this step may be referred to or may be implemented by a document request module, such as document request module 440 of FIG. 4. Execution then proceeds to step 250.

It is understood that the steps shown in FIGS. 1 and 2 may be performed in a different order than shown, additional steps can be provided before, during, and after the steps, and/or some of the steps described can be replaced or eliminated in other embodiments. One or more of the steps can be carried by one or more devices and/or systems described herein, such as components of the compliance management system 100, and/or processor circuit 550.

FIG. 3 is an exemplary representation, in block diagram form, of at least a portion of an example compliance management system 100 in accordance with at least one embodiment of the present disclosure. The compliance management system 100 includes a single page application (SPA) or multi-page application (MPA) 310, or similar user interface application, which may for example be implemented in Glimp and may be accessible through a web browser or other application. The SPA or MPA 310 may for example be a client portal that allows the end user to work with the different features of the compliance management system 100, including sign in, form management and document export in pdf form. The SPA or MPA 310 may run on or be hosted on a hosting service 320 such as Amazon Web Services Swarm (AWS Swarm). The hosting service 320 may for example include a docker swarm routing mesh that is used via an application program interface (API) or web socket to allow communication with the back-end services and to accommodate the front-end application. A number of layers, modules, or microservices 235 may underlie the SPA or MPA 310, including the authentication microservice, layer, or module 120, the PDF microservice, layer, or module 130, the document service microservice, layer, or module 204 (all described above in FIGS. 1 and 2), an auditing microservice, layer, or module 360, and a monitoring stack 370.

In an example, the authentication or auth microservice 120 may be used for authentication and authorization of users, and for encryption and decryption of personal information saved on behalf of users. In an example, the PDF generation microservice 130 is used to pull information from the document microservice 204 and internal translation/rules engine within the PDF generation microservice 130, and create PDFs in real time or near-real time that are then stored in a database 380. In an example, the document microservice 204 is responsible for uploading, encryption and decryption of personal documents used on behalf of the PDF microservice 130.

In an example, the auditing microservice, layer, or module 360 is used to track the users of the system through different events that the user evokes, in communication with an internal database 390 such as a Postgres, PostgreSQL, or structured query language (SQL) relational database, which can be used for example to track the company table and time series information for the monitoring stack 370. In an example, the PDF microservice, layer, or module 130 performs as described above in FIGS. 1 and 2, in communication with a user database 380 such as a DynamoDB or other NoSQL database. In an example, AWS DynamoDB is a noSQL key value database where employee, user, authentication, etc. information can be stored. All personally identifiable information (PII) data may be secured (e.g., encrypted) at rest in the respective tables of the database.

In an example, the internal monitoring stack 370 can serve to keep track of container and nodes information, including but not limited to CPU, memory and disk space allocation information. The monitoring stack 370 may also track individual alerting events from within the codebase such as connectivity loss for the command query responsibility segregation (CQRS) event bus.

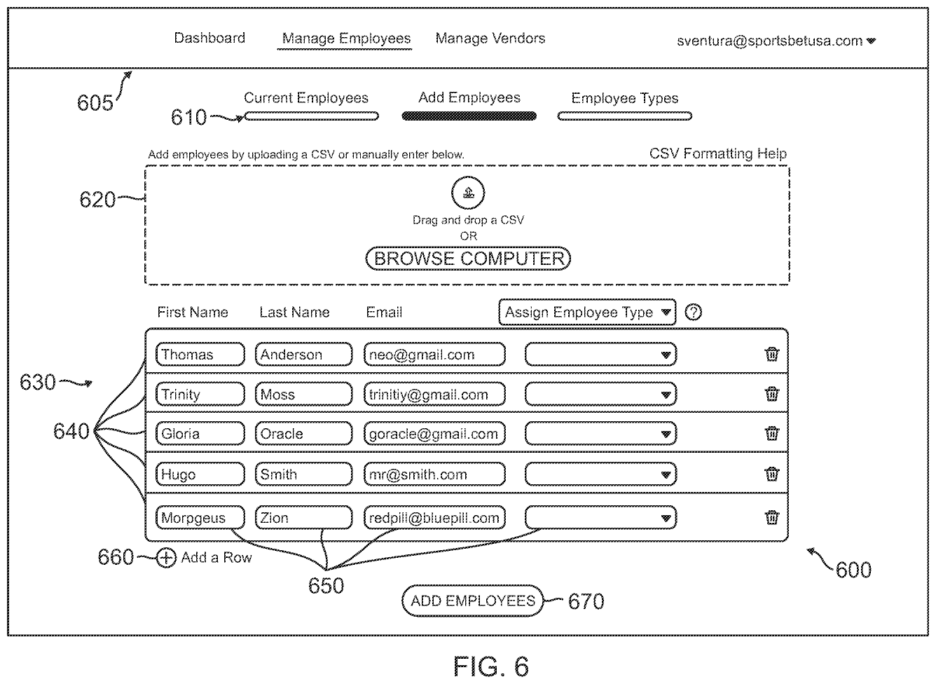

FIG. 4 is an exemplary representation, in block diagram form, of at least a portion of an example compliance management system 100 in accordance with at least one embodiment of the present disclosure. In the example shown in FIG. 4, the compliance management system 100 includes a dashboard module 410. In some embodiments, the dashboard module 410 may be, may include, or may be a part of the SPA or MPA 310 of FIG. 3 and/or the front end 110 of FIG. 1, and may include or generate display screens such as those in FIGS. 6-8, 11, 13, and 15-16.

The compliance management system 100 also includes an encryption module 420, a personal information database 430, a document request module 440, a licensing authority 450, a document preparation module 460, a decryption module 470, a document generation module 480, an overflow module 485, and a submit module 490.

In some embodiments, the dashboard module 410 may be configured to receive personal information from or related to a licensee or applicant 405, and to store the personal information in the personal information database 430 after encryption by the encryption module 420. The document request module 440 may be configured to automatically retrieve a blank license form 455 from a website or remote database of the licensing authority 450. Typically, the license form will comprise multiple fields 457 for entering personal information of the applicant. The document preparation module 460 may be configured to identify each field within the license form and map that field to corresponding information for the licensee or applicant 405 within the personal information database 430. The document generation module 480 may be configured to retrieve the mapped information for each field within the license form for the licensee or applicant 405 from the information storage unit 430 after decryption by the decryption module 470, and to place the retrieved requested information in corresponding fields 457 of the license form 455, to generate a completed form 458. Depending on the implementation, the document generation module 480 may cause the completed form to be displayed on a display, printed on a printer, read aloud by voice synthesis software, etc., or may store the completed form as a document file (e.g., a .pdf, .doc. or .docx file), any combination of these.

In some embodiments, the overflow module 485 may be configured to identify a field 457 within the license form 455 that is too small to contain the requested personal information and to generate, based on a user input, an attachment for the license form including the requested information that exceeds the capacity of that field. Some embodiments include a submit module 490 that is configured to transmit the completed form 458, with or without the attachment, to the licensing authority 450. The completed form may be transient in memory, such that the user's personal information is not stored indefinitely in an unencrypted format. In other embodiments, a user may email the completed form to the licensing authority, or print out the competed form and ship it to the licensing authority.

The encryption module 420 and decryption module 470 may for example be parts of the authentication layer, service, or module 120 of FIG. 1. The document preparation module, document generation module, and overflow module may for example be parts of the PDF generation layer 130 of FIG. 1 or the PDF microservice 130 of FIG. 3. The document request module 440 may for example be part of the document service layer 204 of FIG. 1 or the document microservice 204 of FIG. 3. Other arrangements are possible, and fall within the scope of the present disclosure.

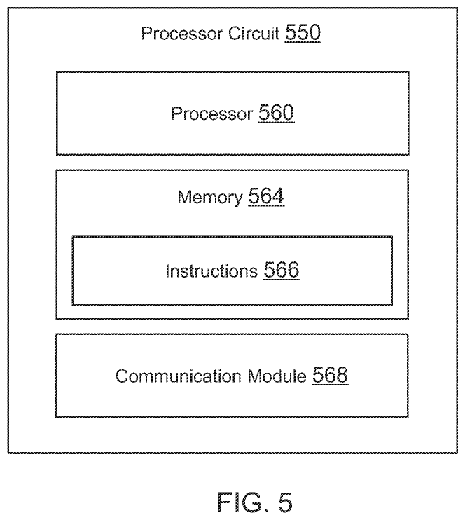

FIG. 5 is a schematic diagram of a processor circuit 550, according to embodiments of the present disclosure. The processor circuit 550 may be implemented in the compliance management system 100, or other devices or workstations (e.g., third-party workstations, network routers, etc.), or on a cloud processor or other remote processing unit, as necessary to implement the method. As shown, the processor circuit 550 may include a processor 560, a memory 564, and a communication module 568. These elements may be in direct or indirect communication with each other, for example via one or more buses.

The processor 560 may include a central processing unit (CPU), a digital signal processor (DSP), a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 560 may also comprise another hardware device, a firmware device, or any combination thereof configured to perform the operations described herein. The processor 560 may also be implemented as a combination of computing devices, e.g., a combination of a DSP and a microprocessor, a plurality of microprocessors, one or more microprocessors in conjunction with a DSP core, or any other such configuration.

The memory 564 may include a cache memory (e.g., a cache memory of the processor 560), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 564 includes a non-transitory computer-readable medium. The memory 564 may store instructions 566. The instructions 566 may include instructions that, when executed by the processor 560, cause the processor 560 to perform the operations described with respect to the FIGS. 1-4 and 6-16. Instructions 566 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 568 can include any electronic circuitry and/or logic circuitry to facilitate direct or indirect communication of data between the processor circuit 550, and other processors or devices. In that regard, the communication module 568 can be an input/output (I/O) device. In some instances, the communication module 568 facilitates direct or indirect communication between various elements of the processor circuit 550 and/or the compliance management system 100. The communication module 568 may communicate within the processor circuit 550 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from different components of the compliance management system) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information.

FIG. 6 shows an “Add Employees” screen 600 of an example compliance management system 100, in accordance with at least one embodiment of the present disclosure. The “Add Employees” screen 600 includes a top menu 605, middle menu 610, a file drop area 620, and manual data entry area 630. The file drop area 620 permits a user to drag and drop files (e.g., from a file system executing on the processor circuit). In an example, the system may be configured to receive Comma Separated Values (CSV) files through the file drop area 620, where each line of the CSV file includes comma-delimited, tab-delimited, or otherwise delimited personal data, or other data, about a list of new employees to be added to the system. In an example, data received from a file dragged and dropped into the file drop area 620 may automatically populate the manual data entry area 630, where the data may be reviewed and, if necessary, edited by the user.

The manual data entry area 630 includes a variable number of records or rows 640. Each record or row 640 describes a single new employee to be added to a database (e.g., the personal information database 430 of FIG. 4), and includes a number of fields 650 such as, for example, “First Name”, “Last Name”, “Email Address”, and “Employee Type”. For each record or row 640, data can be manually entered or edited in each of the fields 650 (e.g., by clicking on them with a mouse and then entering or removing text with a keyboard, although other methods may be used instead or in addition). The manual data entry area 630 also includes an “Add Row” button 660, which can be used to create additional records 640. Also visible is an “Add Employees” button 670, which, when data entry, data upload, or data correction is complete, can be used to copy the records 640 into the personal information database.

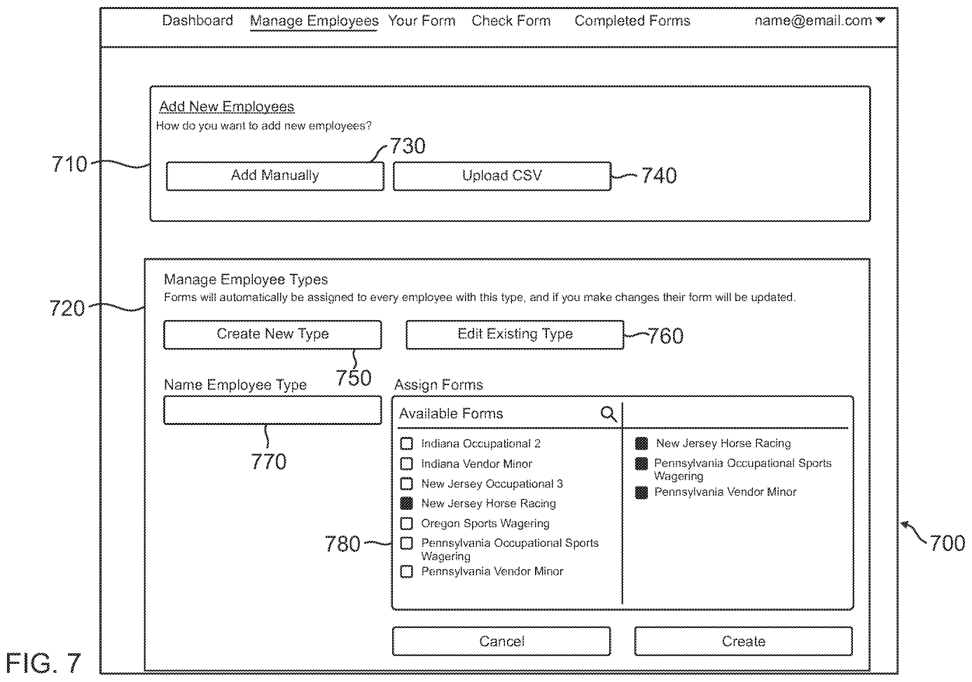

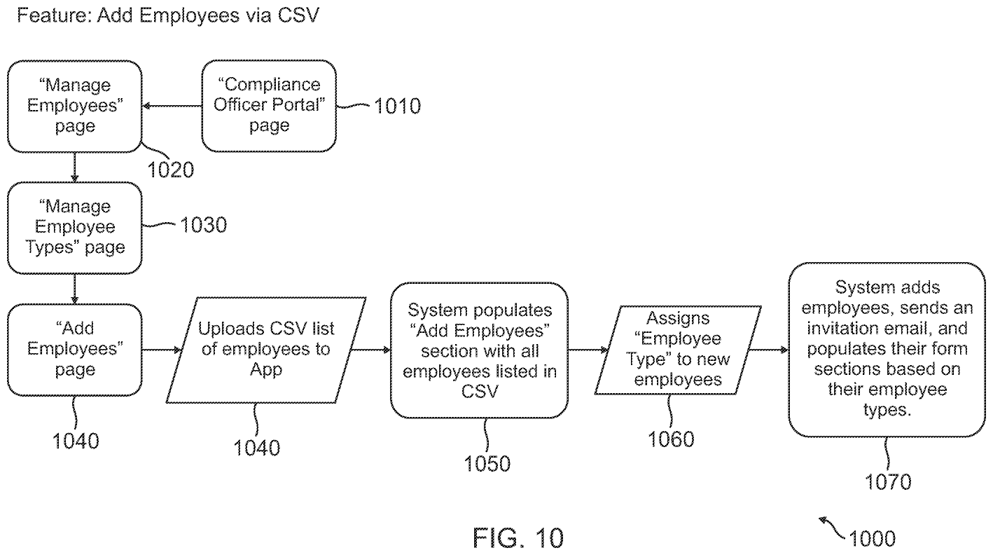

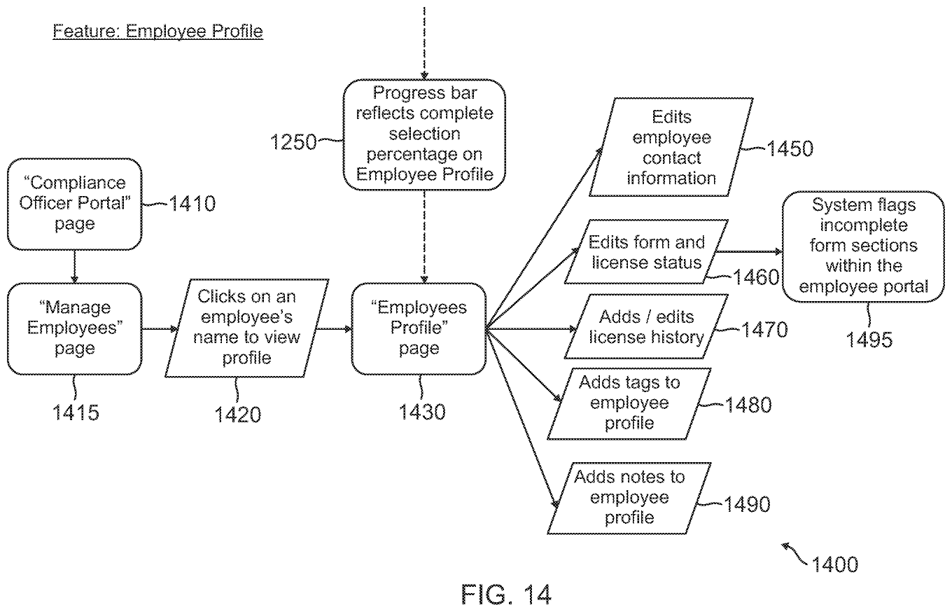

FIG. 7 shows a “Manage Employees” screen 700 of an example compliance management system 100, in accordance with at least one embodiment of the present disclosure. The employee type form assignment screen 700 includes an “Add New Employees” section 710, which includes an “Add Manually” button 730 and an “Upload CSV” button 740. The “Add Manually” button 730 may for example trigger a method such as, or similar to, method 1400 of FIG. 14. The “Upload CSV” button 740 may for example trigger a method such as, or similar to, method 1000 of FIG. 10.

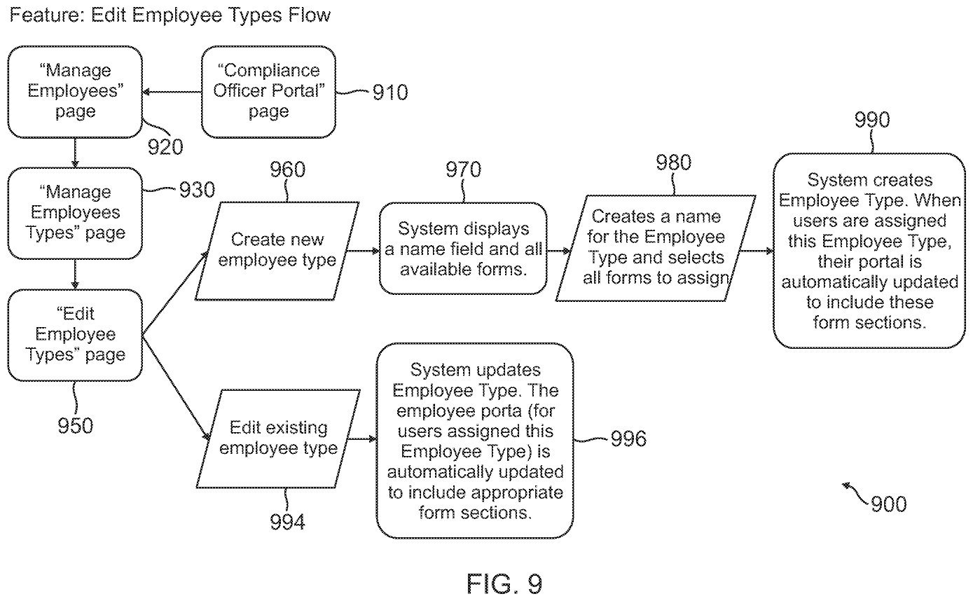

The “Manage Employees” screen 700 also includes a “Manage Employee Types” section 720, which includes a “Create New Type” button 750 and an “Edit Existing Type” button 760. The functioning of the “Create New Type” button 750 and “Edit Existing Type” button 760 may for example be described by a method such as method 900 of FIG. 9.

In the example shown in FIG. 7, the “Create New Type” button 750 has been selected, which has brought up input fields including a “Name Employee Type” field 780 and an “Assign Forms” selector 780. The “Assign Forms” selector 780 may for example allow a user to select all the forms that will be associated with the new user type.

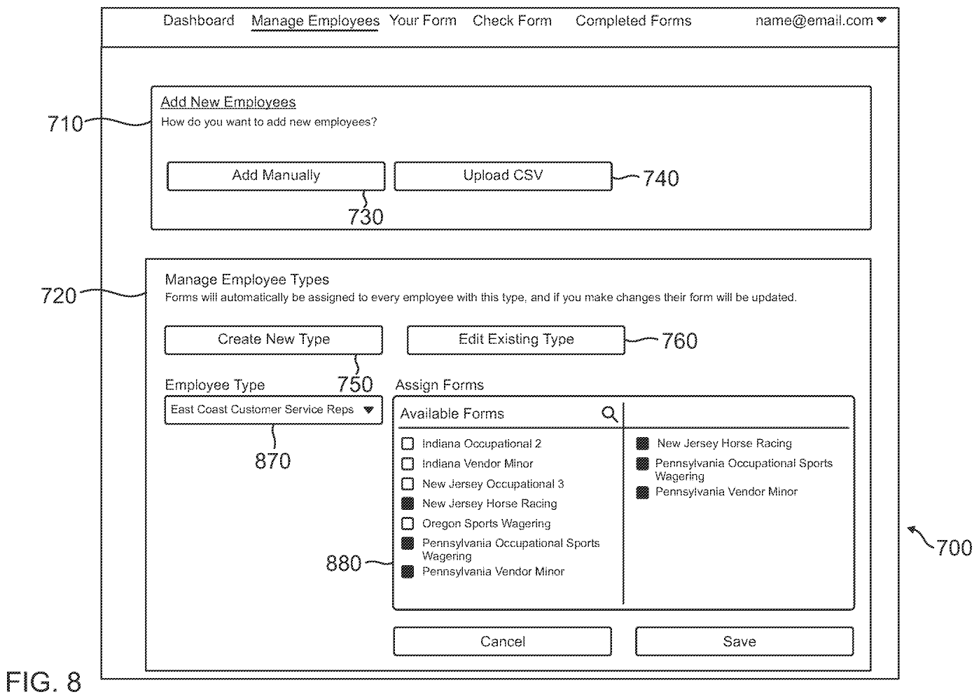

FIG. 8 shows a “Manage Employees” screen 700 of an example compliance management system 100, in accordance with at least one embodiment of the present disclosure. The “Manage Employees” screen 700 shown in FIG. 8 is similar to the “Manage Employees” screen 700 shown in FIG. 7. However, in the example shown in FIG. 8, the “Edit Existing Type” button 760 of the “Manage Employee Types” section 720 has been selected, which has brought up input fields including an “Employee Type” selector 870 and an “Assign Forms” selector 880. The “Assign Forms” selector 880 may for example allow a user to change the selection of forms that will be associated with the selected employee type.

FIG. 9 is an exemplary representation, in flow diagram form, of at least a portion of an example compliance management method 900 in accordance with at least one embodiment of the present disclosure. The method 900 may for example be a method for editing or creating employee types.

In step 910, based on user input, the system enters the compliance officer portal (as shown for example in FIG. 6). Execution then proceeds to step 920.

In step 920, based on user input (e.g., through the top menu 605 or middle menu 610 of the screen display 600 of FIG. 6), the system navigates to a “Manage Employees” page, screen, menu, or pop-up window (e.g., screen 700 of FIG. 7 or FIG. 8). Execution then proceeds to step 930.

In step 930, based on user input, the system navigates to an “Employee Types” or “Manage Employee Types” page, screen, menu, or pop-up window (e.g., section 720 of FIG. 7 or FIG. 8). Execution then proceeds to step 950.

In step 950, from the “Employee Types” page, based on user input, the system chooses between navigating to a “Create New Employee Type” page, screen, menu, or pop-up window (in which case execution proceeds to step 960), or an “Edit Employee Type” page, screen, menu, or pop-up window (in which case execution proceeds to step 994).

In step 960, the system navigates to the “Create New Employee Type” page, screen, menu, or pop-up window. Execution then proceeds to step 970.

In step 970, the system displays a name field and all available forms for the new employee type. Execution then proceeds to step 980.

In step 980, based on user input, the system creates a name for the new employee type, and selects all forms to assign to that employee type. Execution then proceeds to step 990.

In step 990, the system creates the new employee type. When employees are assigned this employee type, their portal is automatically updated to include all the form sections for that employee type. The method is now complete.

In step 994, the system navigates to the “Edit Employee Type” page, screen, menu, or pop-up window. Execution then proceeds to step 996.

In step 996, based on user input, the system updates the employee type (e.g., the name, assigned forms, or assigned form sections). The employee portal for employees of this employee type is then automatically updated to include appropriate forms or form sections associated with the employee type. The method is now complete.

FIG. 10 is an exemplary representation, in flow diagram form, of at least a portion of an example compliance management method 1000, in accordance with at least one embodiment of the present disclosure. The method 1000 may for example be a method for adding multiple users to the system via a “comma separated values” or CSV file.

In step 1010, based on user input, the system enters compliance officer portal (as shown for example in FIG. 6). Execution then proceeds to step 1020.

In step 1020, based on user input (e.g., through the top menu 605 or middle menu 610 of the screen display 600 of FIG. 6), the system navigates to a “Manage Employees” page, screen, menu, or pop-up window (e.g., screen 700 of FIG. 7 or FIG. 8).

In step 1030, the system displays the “Add Employees” page, screen, menu, or pop-up window (as shown for example in FIG. 6), where input can then be received from the user indicating a CSV file to be uploaded (e.g., through the file drop area 620 of FIG. 6). Execution then proceeds to step 740.

In step 1040, the system uploads the CSV file containing employee data. Execution then proceeds to step 1050.

In step 1050, the system populates the “Add Employees” section of the “Add Employees” screen (e.g., section 630 of screen 600 of FIG. 6) with all of the employees listed in the CSV file, along with their personal and identifying information stored in the CSV file. Execution then proceeds to step 1060.

In step 1060, based on user inputs, the system assigns an employee type to each of the new employees. In some embodiments, employee data for the new employees can be manually edited at this step, as described above in FIG. 6. Execution then proceeds to step 1070.

In step 1070, the system adds the new employees to a database (e.g., the Personal Information Database 430 of FIG. 4), sends an invitation email to each employee, and populates each employee's form sections based on their employee types. The method is now complete.

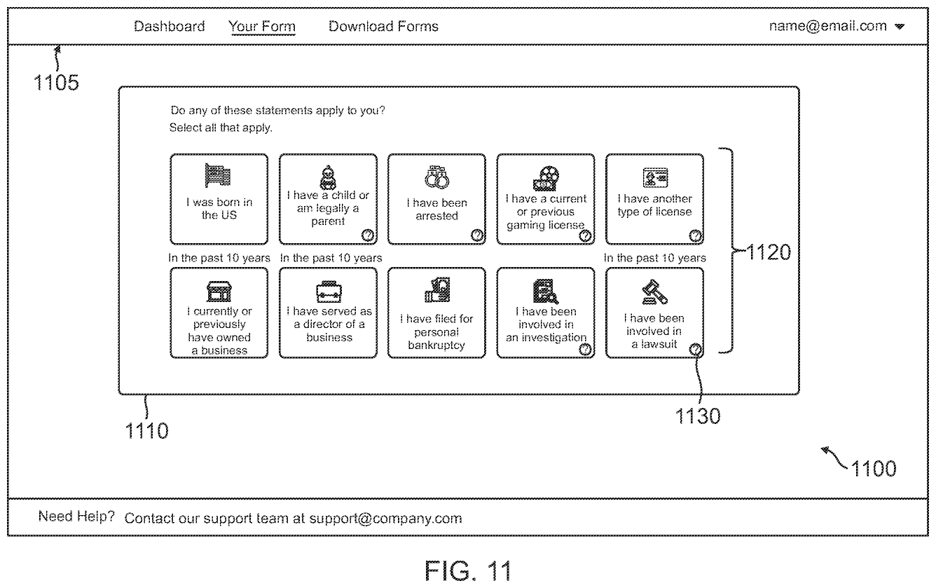

FIG. 11 shows a personal statement selector screen 1100 of an example compliance management system 100, in accordance with at least one embodiment of the present disclosure. Visible is a top menu 1105, statements menu 1110, and a plurality of statements 1120. A user, upon entering the personal statement selector screen 1100, may for example click on any or all of the statements 1120 that apply to a particular employee. In some cases, the particular employee and the user are the same person, although this may not always be the case. Possible statements include, but are not limited to, “I was born in the US”, “I have a child or am legally a parent”, “I have been arrested”, “I have a current or previous gaming license”, “I have another type of license”, “I currently or previously have owned a business”, “I have served as a director of a business”, “I have filed for personal bankruptcy”, “I have been involved in an investigation”, and/or “I have been involved in a lawsuit”. Depending on the implementation, other statements, other types of statements, other numbers of statements may be used instead or in addition. In some embodiments, some or all of the statements 1120 may include a “More Information” button 1130, which may (e.g., when clicked) activate a pop-up display, information screen, or other display providing the user with additional information about that particular statement.

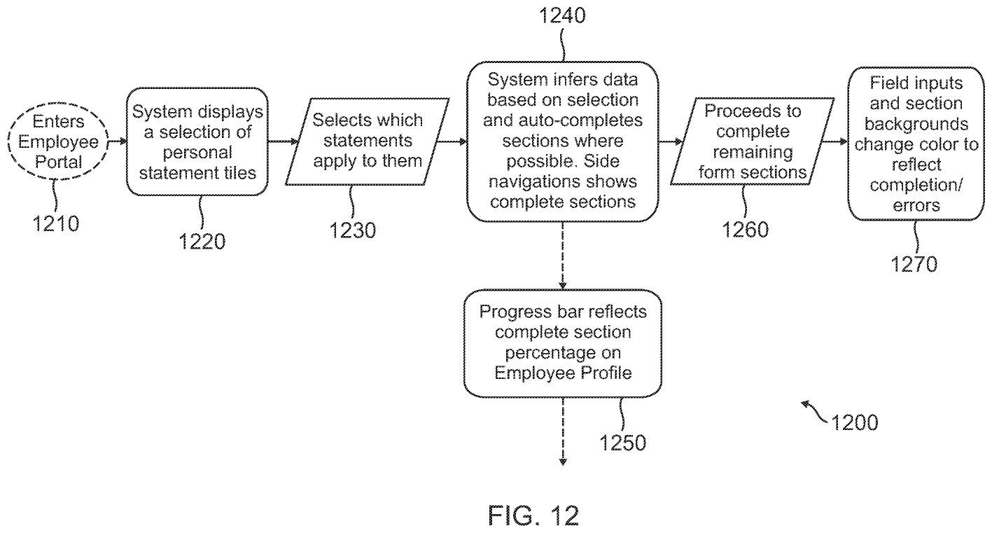

FIG. 12 is an exemplary representation, in flow diagram form, of at least a portion of an example compliance management method 800, in accordance with at least one embodiment of the present disclosure. The method 800 may for example be a method for displaying and functionalizing a personal statement selector and completion indicator.

In step 1210, based on user input, the system enters the employee portal (as shown for example in FIG. 11). Execution then proceeds to step 1220.

In step 1220, the system displays a selection of personal statement tiles that are selectable by the user (e.g., an employee, or a user operating the system on behalf of the employee). Execution then proceeds to step 1230.

In step 1230, based on user input, the system selects which statements apply to the employee. Execution may proceed temporarily to step 1250 to update a progress indicator, and then return. When all applicable statements have been selected, execution then proceeds to step 1240 based on a user input.

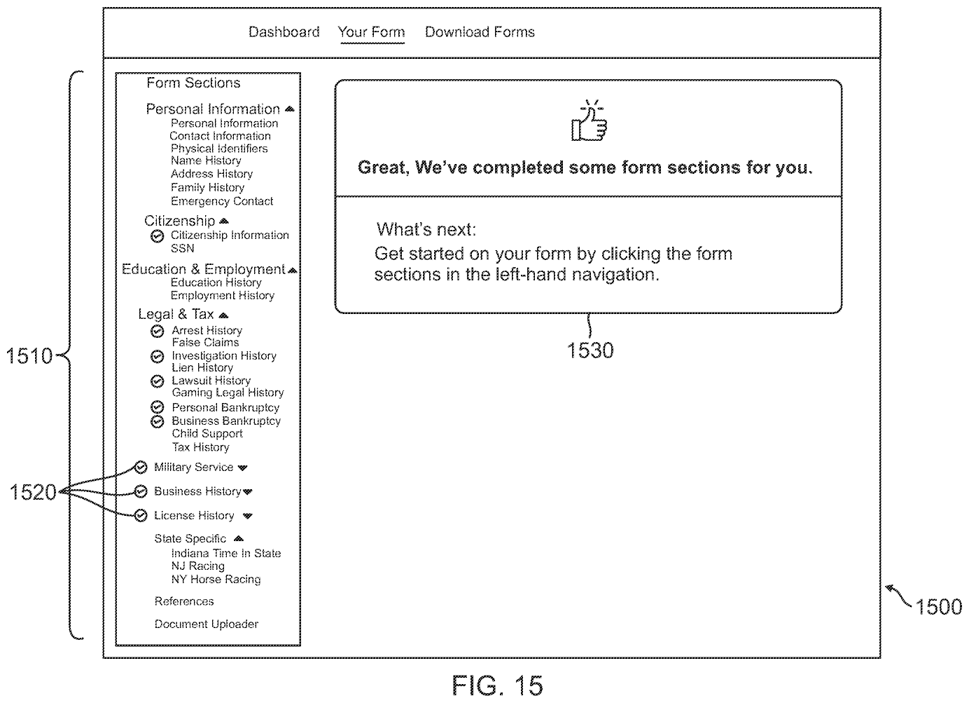

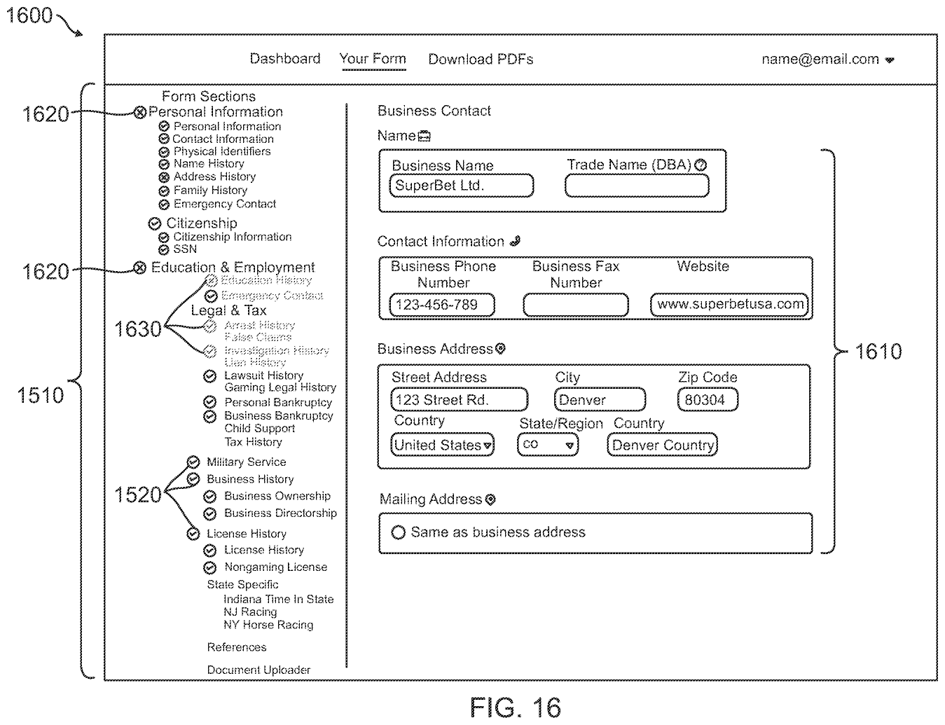

In step 1240, the system infers data based on the selected personal statements, and auto-completes form sections where possible. In some embodiments, execution may then proceed temporarily to step 1250 temporarily, to update a progress indicator, and then return. In some embodiments, a side navigation block (e.g., side navigation block 1510 of FIG. 15 or FIG. 16) is updated to show completed sections and/or sections that still need to be completed by the user. Execution then proceeds to step 1260.

In step 1250, the system updates a progress bar or other progress indicator to indicate a percent completion of the current section. Execution then returns to the step from which step 1250 was called.

In step 1260, based on user input, the system proceeds to complete any remaining form sections. In some embodiments, execution may proceed temporarily to step 1250 to update a progress indicator, and then return. Execution then proceeds to step 1270.

In step 1270, field inputs and section backgrounds of the side navigation block change color to reflect whether they are complete, incomplete, or contain errors. If any sections are incomplete or contain errors, execution may return to step 1260. If all sections are complete, then the method is complete.

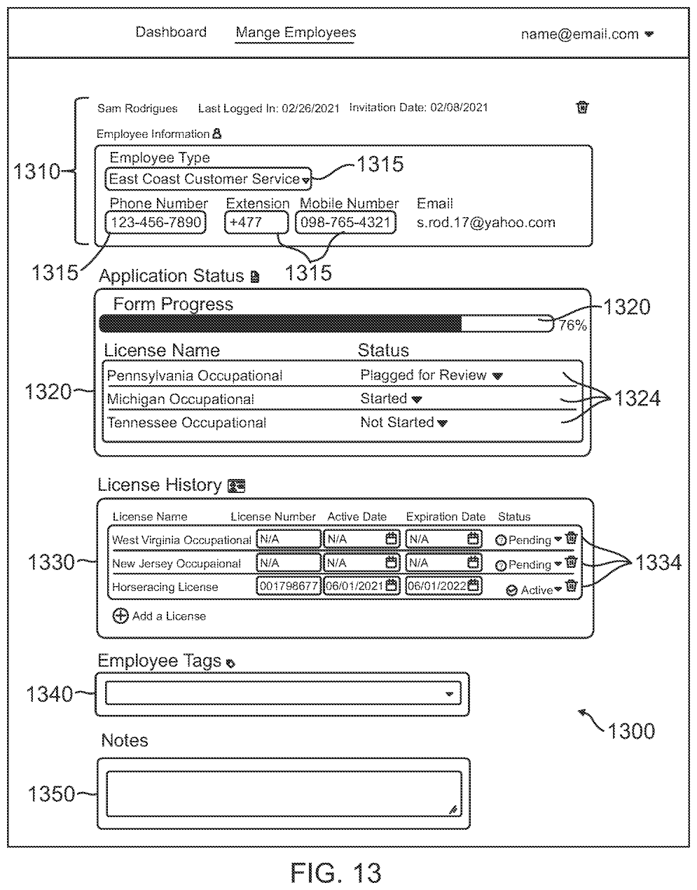

FIG. 13 is an employee profile screen 1300 of an example compliance management system 100, in accordance with at least one embodiment of the present disclosure. The employee profile screen 1300 includes an employee information section 1310, which includes fields 1315 containing identifying information, personal information, employee type, and other information as needed to describe the employee. In some embodiments, the fields 1315 may be edited directly on the employee profile screen 1300. In other embodiments, the fields 1315 are populated using information obtained in other portions of the system (e.g., FIG. 6), and are not editable from within the employee profile screen 1300.

The employee profile screen 1300 also includes an application status section 1320, which includes a form progress indicator 1322 and a fixed or variable number of records 1324 pertaining to licenses applied for by the employee. The progress indicator 1322 may for example show the percent completed for a form in a selected record 1324 or, if no record 1324 is selected, a percent completed for all of the forms for which records 1324 are displayed.

The employee profile screen 1300 also includes a license history section 1330, which includes a variable number of records 1334, each containing information (e.g., fields) pertaining to a specific license currently or previously held by the employee.

The employee profile screen 1300 also includes an employee tags section 1340, in which text can be displayed and/or edited that describes specific (e.g., employer-specific) information about the employee. Example tags may include, but are not limited to, managers of the employee, team names, hiring date, cohort, or class.

The employee profile screen 1300 also includes a notes section 1350, in which text can be displayed and/or edited that does not fit into any other defined fields of the employee profile screen 1300. Example notes may include, but are not limited to, concerns about the application, follow ups needed to be taken on the employee, or information regarding the unique condition of that employee.

The employee profile screen 1300 may for example trigger, or be called by, the method of FIG. 14.

FIG. 14 is an exemplary representation, in flow diagram form, of at least a portion of an example compliance management method 1400 in accordance with at least one embodiment of the present disclosure. The method 1400 may for example be an employee profile input or editing method.

In step 1410, based on user inputs, the system enters the compliance officer portal (as shown for example in FIG. 6, FIG. 7, or FIG. 8). Execution then proceeds to step 1415. In some embodiments, based on user inputs, the system enters the employee portal instead of the compliance officer portal, in which case execution proceeds to step 1420.

In step 1415, based on user input (e.g., through the top menu 605 or middle menu 610 of the screen display 600 of FIG. 6), the system navigates to a “Manage Employees” page, screen, menu, or pop-up window (e.g., screen 700 of FIG. 7 or FIG. 8). Execution then proceeds top step 1420. In embodiments where the system entered the employee portal in step 1410, this step may not occur.

In step 1420, the system receives a user input selecting the name of an employee whose profile will be viewed. Execution then proceeds to step 1430.

In step 1430, the system displays the “Employee Profile” page (e.g., Employee Profile Page 1300 of FIG. 13). Step 1430 can be reached from step 1420, or from step 1250 (shown in both FIG. 12 and FIG. 14). Execution may proceed temporarily to step 1250 and then return. Based on user inputs, execution then proceeds to step 1450, step 1460, step 1470, step 1480, or step 1490. If the user inputs indicate that all the desired information has been entered or edited, then the method is complete.

In step 1250, the system updates a progress bar or other progress indicator to reflect a percent completion for the current section. Execution then returns to the step that called step 1250.

In step 1450, based on user inputs, the system edits the contact information for the selected employee. Execution then returns to step 1430.

In step 1460, based on user inputs, the system edits forms and license status or statuses for the selected employee. Execution then proceeds to step 1495.

In step 1470, based on user inputs, the system adds or edits license history information in the profile for the selected employee. Execution then returns to step 1430.

In step 1480, based on user inputs, the system adds tags to the profile for the selected employee. Example tags may include, but are not limited to, managers of the employee, team names, hiring date, cohort, or class. Execution then returns to step 1430.

In step 1490, based on user inputs, the system adds notes to the profile for the selected employee. Example notes may include, but are not limited to, concerns about the application, follow ups needed to be taken on the employee, or information regarding the unique condition of that employee. Execution then returns to step 1430.

In step 1495, the system flags incomplete form sections within the employee portal, and/or form sections that contain errors. In some embodiments, such flagging may for example take the form of a color-coded list, where completed form sections are indicated by a first color, incomplete sections are indicated by a second color, and sections that contain an error are indicated by a third color. In other embodiments, such flagging may be accomplished through text, icons, symbols, shading, flashing, or otherwise. Execution then returns to step 1430.

FIG. 15 is a completed personal statement selector screen 1500 of an example compliance management system 100, in accordance with at least one embodiment of the present disclosure. Visible is a list of forms 1510 that have been determined to be required for a given employee. Forms 1510 may be added to the list based on personal information, personal statements, state or country of residence, state or country of employment, or other information depending on the implementation. Some forms 1510 in the list include a check box 1520 or similar indicator, indicating that that particular form 1510 has already been completed. In an example, the check box 1520 may indicate that all available fields, all required fields, or all mandatory fields of the particular form 1510 have been populated with information pertaining to the given employee. Also visible is a status indicator and instruction box 1530, which includes information relevant to the user for completion of the forms 1510.

FIG. 16 is a side navigation and completion indicators screen of an example compliance management system 100, in accordance with at least one embodiment of the present disclosure. Visible is a list of forms 1510 that have been determined to be required for the employee. Some forms 1510 in the list include a check box 1520 or similar indicator, indicating that that particular form 1510 has already been completed. Other forms 1510 include an “X” 1620 or similar indicator, indicating that that particular form has not been completed or contains an error or missing information. Some forms 1510 include a “grayed out” indicator 1630, indicating information in that section may not be required in order to enable a check box or similar indicator (e.g., may not be necessary to complete for the currently selected employee).

A number of variations are possible on the examples and embodiments described above. For example, the technology described herein may be applied to downloadable documents of numerous sorts, including gaming license applications, liquor license applications, tasting room license applications, insurance, and others. The personally identifying information (PII) may be stored in an encrypted, unencrypted, doubly encrypted, or multiply encrypted state. Some microservices may run on separate processors (e.g., connected over a network), or may be combined into a smaller number of services or layers. Multiple databases may be employed, or the functions of databases 380 and 390 of FIG. 3 may be combined into a single database. The system may employ other document formats, other encryption schemes, other authentication schemes, other file storage and retrieval architectures, etc., while still falling within the scope of the specification and claims.

Accordingly, the logical operations or elements making up the embodiments of the technology described herein may be referred to variously as operations, steps, objects, elements, components, modules, services, microservices, layers, or otherwise. Furthermore, it should be understood that these may occur or be performed or arranged in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the compliance management system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the compliance management system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A compliance management system comprising:
one or more processors;
a personal information database; and
a non-transitory computer-readable storage medium storing instructions, wherein the instructions, when executed by the one or more processors, cause the one or more processors to provide a plurality of functional modules including:
a dashboard module configured to receive personal information related to a licensee, and to store the personal information in the personal information database;
a document request module configured to automatically retrieve a license form from a website or remote database, wherein the license form comprises a plurality of fields;
a document preparation module configured to identify each field within the license form and map that field to corresponding information for the licensee within the personal information database;
a document generation module configured to retrieve the corresponding information for each respective field within the license form for the licensee from the personal information database and to place the corresponding retrieved information in the respective fields of the license form to generate a completed form; and
an overflow module configured to identify an overflowed field within the license form wherein a capacity of the overflowed field is insufficient to contain the retrieved information for that field, and to generate, based on a user input, an attachment for the license form including the retrieved information for that field.

2. The system of claim 1, further comprising instructions to cause the one or more processors to provide a submit module configured to transmit the completed form and the attachment to a licensing authority.

3. The system of claim 2, further comprising instructions to cause the one or more processors to provide a refresh module configured to, when personal information for the licensee stored in the personal information database is altered, repopulate the form using the document generation module and resubmit the form using the submit module.

4. The system of claim 1, wherein the dashboard module is configured to receive the personal information related to the licensee through a single application form displayed on a display, wherein the personal information is entered with a keyboard and a pointing device.

5. The system of claim 1, further comprising instructions to cause the one or more processors to provide:
an encryption module configured to encrypt the personal information stored in the personal information database; and
a decryption module configured to decrypt the personal information retrieved from the personal information database.

6. The system of claim 1, wherein the personal information related to the licensee includes an image.

7. The system of claim 1, wherein the personal information database is a nosql database.

8. The system of claim 1, wherein the personal information database is cloud-based.

9. The system of claim 1, wherein the document request module is configured to retrieve at least one license form of a plurality of different license forms.

10. The system of claim 1, further comprising instructions to cause the one or more processors to provide a user interface within the dashboard module, the user interface comprising:
an employee portal configured to accept first user inputs regarding a selected employee; and
a compliance officer portal configured to accept second user inputs regarding at least one of a new employee, a plurality of new employees, an existing employee, an employee type, or a business contact.

11. The system of claim 10, wherein the first user inputs comprise at least one of personal information, personal statements information, license information, license history information, employee tags, or notes.

12. The system of claim 10, wherein the second user inputs comprise at least one of:
a name of the employee type;
a selection of forms associated with the employee type;
employee information associated with an employee, the employee information comprising personal information, personal statements information, license information, license history information, employee tags, or notes; or
business contact information associated with a business contact, the business contact information comprising name, contact information, business address, or mailing address.

13. A method comprising:
receiving personal information related to a licensee, and storing the personal information in a personal information database;
automatically retrieving a license form from a website or remote database, wherein the license form comprises a plurality of fields;
identifying each field within the license form and map that field to corresponding information for the licensee within the personal information database; and
retrieving the corresponding information for each respective field within the license form for the licensee from the personal information database; and
generating a completed form, including placing the corresponding retrieved information in the respective fields of the license form.

14. The method of claim 13 further comprising:
identifying an overflowed field within the license form wherein a capacity of the overflowed field is insufficient to contain the retrieved information for that field; and
generating, based on a user input, an attachment for the license form including the retrieved information for that field.

15. The method of claim 14 further comprising:
transmitting the completed form and the attachment to a licensing authority.

16. The method of claim 13, further comprising:
accepting first user inputs regarding a selected employee,
wherein the first user inputs comprise at least one of personal information, personal statements information, license information, license history information, employee tags, or notes; and
accepting second user inputs regarding at least one of a new employee, a plurality of new employees, an existing employee, an employee type, or a business contact.

17. The method of claim 16, wherein the second user inputs comprise at least one of:
a name of the employee type;
a selection of forms associated with the employee type;
employee information associated with an employee, the employee information comprising personal information, personal statements information, license information, license history information, employee tags, or notes; or
business contact information associated with a business contact, the business contact information comprising name, contact information, business address, or mailing address.

18. A computer program product having a non-transitory computer readable medium tangibly recording computer program logic for managing license application compliance, the computer program product comprising:
code to receive personal information related to a licensee, and to store the personal information in a personal information database;
code to automatically retrieve a license form from a website or remote database, wherein the license form comprises a plurality of fields;
code to identify each field within the license form and map that field to corresponding information for the licensee within the personal information database; and
code to retrieve the corresponding information for each respective field within the license form for the licensee from the personal information database and to place the corresponding retrieved information in the respective fields of the license form to generate a completed form.

19. The computer program product of claim 18 further comprising:
code to identify an overflowed field within the license form wherein a capacity of the overflowed field is insufficient to contain the retrieved information for that field, and to generate, based on a user input, an attachment for the license form including the retrieved information for that field.

20. The computer program product of claim 19 further comprising:
code to transmit the completed form and the attachment to a licensing authority.
